(19) United States
(12) Patent Application Publication
(10) Pub. No.: US 2023/0377081 A1
(43) Pub. Date: Nov. 23, 2023

(54) NOVEL COMMUNICATIONS SYSTEM FOR MOTORISTS

(71) Applicant: Malik Azim, Oakland, CA (US)

(72) Inventor: Malik Azim, Oakland, CA (US)

(21) Appl. No.: 18/227,949

(22) Filed: Jul. 30, 2023

Related U.S. Application Data
(63) Continuation of application No. 16/932,871, filed on Jul. 20, 2020.

(51) Int. Cl. G06Q 50/26; H04N 7/18; G06Q 50/18

(52) U.S. Cl. CPC G06Q 50/265; H04N 7/188; G06Q 50/18; H04N 7/183

(57) ABSTRACT

The present invention relates to a central communications system and method for motorists which can be employed during law enforcement investigations. The method includes receiving from a set of servers at a first device operated by legal counsel a first set of notifications from a plurality of motorists within a pre-determined location that seek legal representation during a traffic stop. Next, send from the first device to a second device a first indication which includes an assent to legal representation for a first selected motorist of the plurality of motorists. Further, create a first channel of communication between law enforcement present at the traffic stop and the legal counsel. Finally, create a second channel of communication between the legal counsel and the first selected motorist via the first device.

### CROSS REFERENCE TO RELATED APPLICATIONS

This patent application claims the benefit of U.S. Provisional Ser. No. 62/436,504 filed Dec. 20, 2016 under 35 U.S.C. § 119(e), further claims the benefit of U.S. Non-Provisional application Ser. No. 15/598,154 filed May 17, 2017 under 35 U.S.C. § 120, further claims the benefit of Continuation-In-Part U.S. Non-Provisional application Ser. No. 16/932,871 filed Jul. 20, 2020 under 35 U.S.C. § 120 which incorporated by reference herein.

### FIELD

The present invention relates to a novel communications system for motorists which can be employed during law enforcement investigations.

### BACKGROUND

High-profile police killings of unarmed African Americans and the protests that precipitate therefrom have caused the American public to reconsider the wide latitude of authority given to police officers. Although many Americans are subjected to police brutality, African Americans have been systematically victimized. In the estimation of many experts, a key factor contributing to the victimization of African Americans is the infiltration of anti-black racism amongst law enforcement.

Traffic stops are the most common interaction that motorists have with law enforcement and therefore play a central role in forming public perceptions. Frequent stops for minor traffic violations, especially if followed by a search of a motorist's vehicle, sends a message to communities of color that they are perceived as potential suspects.

A recent study concluded that African Americans are nearly twice as likely to be pulled over as other Americans and about four times as likely to be searched. Therefore, a need exists for a communications system for motorists which can be employed during law enforcement investigations.

### BRIEF DESCRIPTION OF THE DRAWINGS

To facilitate understanding, identical reference numerals have been used, wherever possible, to designate identical elements that are common to the figures. The drawings are not to scale and the relative dimensions of various elements in the drawings are depicted schematically and not necessarily to scale. The techniques of the present invention may readily be understood by considering the following detailed description in conjunction with the accompanying drawings, in which:

FIG. 1 is an example computer network system according to one or more examples of the present invention.

FIG. 2 is an illustration of a motorist prior to a traffic stop according to one or more examples of the present invention.

FIG. 3 is an illustration of a system for engaging with law enforcement during a traffic stop according to one or more examples of the present invention.

FIGS. 4A-4E are illustrations of a vehicle with system devices which facilitate communication between a motorist, its legal counsel, and law enforcement during a traffic stop, investigative stop, or detention.

FIG. 5 is an illustration of a computing system which can facilitate a communications system between remote parties during an investigation by law enforcement according to one or more examples of the present invention.

### DETAILED DESCRIPTION

Before the present invention is described in detail, it is to be understood that, unless otherwise indicated, this disclosure is not limited to specific procedures or articles, whether described or not.

It is further to be understood that the terminology used herein is for the purpose of describing particular embodiments only and is not intended to limit the scope of the present invention.

It must be noted that as used herein, and in the claims, the singular forms “a,” and “the” include plural referents unless the context clearly dictates otherwise.

Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure. The term “about” generally refers to ±10% of a stated value.

The present invention relates to a communications system and method for motorists to be employed during law enforcement investigations. The method includes receiving an indication that a motorist is being investigated by law enforcement. The method further includes presenting options of available legal counsel. Next, the method includes facilitating a selection of legal counsel of available legal counsel options to represent the motorist during the law enforcement investigation. Further, the method includes creating a first channel of communication between law enforcement and the motorist's legal counsel.

Herein, a traffic stop is defined as a temporary detention of a motorist by law enforcement to investigate a possible crime or minor violation of law. An investigative stop, or terry stop, is defined as a brief detention. Notably, for investigative stops, law enforcement must have a reasonable suspicion that a suspect is engaged in criminal activity in order to justify the temporary stop. A detention occurs whenever a police officer accosts an individual and restricts his or her freedom when suspected of being involved in criminal activity.

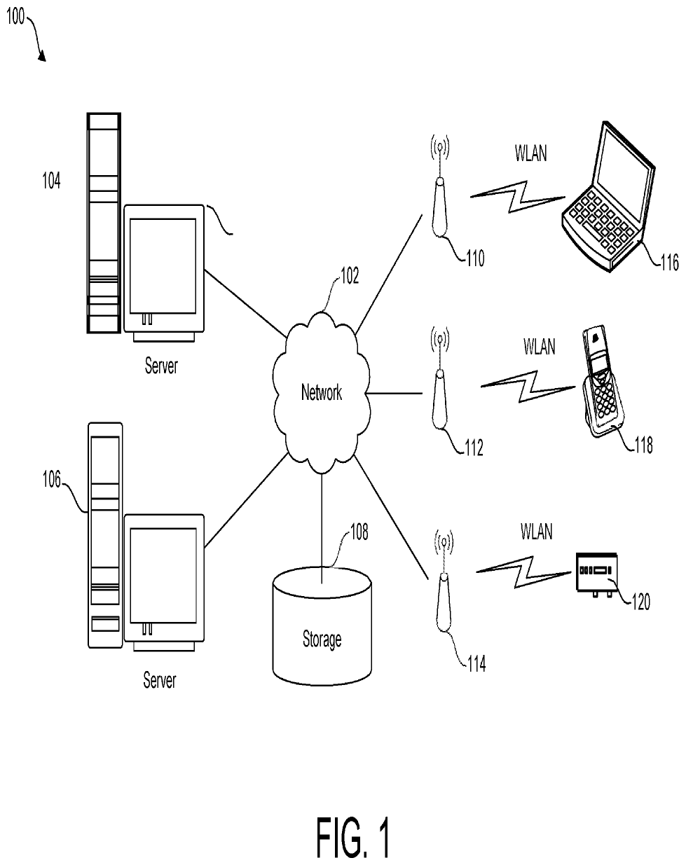

FIG. 1 is an example computer network system 100 according to one or more examples of the present invention. Computer network system 100 is a network of data processing systems, such as, for example, computers and other devices, in which the illustrative embodiments may be implemented. One or more client devices employed within computer network system 100 may include a display screen, a plurality of microprocessors, and memory.

Computer network system 100 may include one or more networks which provide communication links between the various computers and other devices connected together within the computer network system 100. In some implementations, network 102 may include connections, such as wire(s), wireless communication links, or fiber optic cables.

In the example depicted in computer network system 100, a server 104, server 106, and storage unit 108 are all connected to network 102. Storage unit 108 may be capable of storing data in a structured or unstructured format. Additionally, storage unit 108 may represent a plurality of storage units coupled to network 102. In some implementations of the present invention, the storage unit 108 may, for example, include any database within an enterprise that stores and manages reusable software assets and any other data related to these reusable software assets. Access Points 110, 112, and 114 may function as a network device that allows client devices to connect to a wired network. In some implementations, an access point may connect to a router as a standalone device but may also be an integral component of the router itself in some implementations.

In addition, the access points 110, 112, 114 may provide wireless access to client devices 116, 118, 120. The client devices may include personal computers, network computers, laptop computers, hand-held computers, personal digital assistants (PDAs), or smart cellular telephones (e.g., smartphones). However, one having ordinary skill in the art should appreciate that the present invention is not limited to the client devices is not limited to the aforementioned devices.

In the implementation shown, access points 110, 112, and 114 are clients to server 104 and/or server 106. In addition, server 104 and/or server 106 may provide data, such as, for example, boot files, operating system images, and applications to access points 110, 112, and 114. In an example implementation, servers 104, 106 can connect central communications units stationed in vehicles such that the system disclosed herein can send and receive communications such as, but not limited to, attorney profiles, vehicle addresses, distress signals, etcetera. Moreover, computer network system 100 may include additional servers, clients, and other devices not shown to implement processes of illustrative implementations.

Computer network system 100 may be implemented as a number of different types of networks, such as, for example, an intranet, a local area network (LAN), a wide area network (WAN), or the Internet. Also, it should be noted that FIG. 1 is only intended as an example and not as an architectural limitation for the different illustrative implementations. For example, illustrative implementations may be implemented within a single data processing system or within a computer network system.

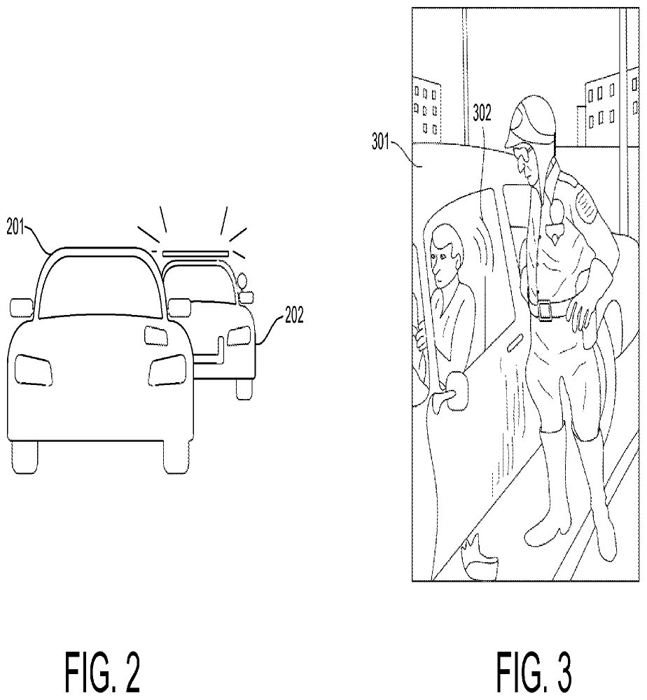

FIG. 2 is an illustration of a motorist prior to a traffic stop according to one or more examples of the present invention. As shown, a motorist's vehicle 201 is being tailed by a police car 202 prior to a traffic stop. Advantageously, the present invention provides for the motorist to be informed of the police car's 202 presence or location prior to a traffic stop. The present invention further provides a motorist a means to identify legal counsel to represent them during its interaction with law enforcement.

Most notably, the present invention can reduce the risk of escalated interactions between law enforcement and motorists. Advantageously, legal counsel (e.g., criminal defense attorneys) can represent its client motorists remotely by communicating directly with law enforcement personnel and further communicating directly with its client motorists to inform them of their rights during law enforcement investigations (e.g., traffic stops, investigative stops, or detentions). As such, the present invention can facilitate motorists to exercise its 6th Amendment right to counsel during law enforcement investigations.

Additionally, the present invention may incorporate a system which identifies legal counsel to potentially represent a motorist according to its present location. In some implementations, each legal counsel within the system's database may indicate the location of a legal counsel's business address, area of practice, and jurisdictions that the legal counsel is authorized to practice. For example, if a motorist is presently driving in Oakland, California, each criminal defense attorney in Oakland, California or Alameda County, depending on system settings, may receive a notification if the motorist needs legal counsel. The legal counsel may also have access to the software system and can make an election if they agree to receive notifications. More specifically, each legal counsel can elect to receive notifications for specific matters (e.g., traffic stops) and for specific regions.

For example, if an attorney with access to the software system disclosed herein elects to receive notifications for traffic stops in Oakland, CA, the attorney may receive the notifications based on its proximity to the detention location. In some implementations, the attorneys may receive preferences to represent the motorist based on round-robin method, random selection, etcetera.

The software system may operate continuously to identify potential legal counsel even without an explicit request from motorists or in response to a detection that a law enforcement investigation has occurred. However, it should be understood by those having ordinary skill in the art that the present invention is not limited to legal counsel as licensed attorneys. In some implementations, legal counsel may be non-attorneys, such as, but not limited to, paralegals. However, for non-attorney legal counsel, they may advise the motorists of their rights prior to or during the law enforcement investigation in a manner that does not interfere with the investigation and in a manner that does not constitute the unauthorized practice of law. In this embodiment, the non-attorney counsel may serve as an observer or witness to law enforcement investigation.

A software system consistent with the present invention can facilitate various account options. For example, the software system may provide a basic subscriber account which gives motorists access to legal counsel for representation during law enforcement investigations. In addition, a premium subscription account can give motorists access to post-investigation services such as, but not limited to, legal counseling, a personally assigned attorney, legal representation in a court of law, etcetera.

FIG. 3 is an illustration of a system for engaging with law enforcement during a traffic stop according to one or more examples of the present invention. As shown, a member of law enforcement has approached a motorist's vehicle possibly for an alleged traffic violation. Notably, upon approaching a motorist's driver-side window, the motorist's legal counsel can communicate with law enforcement to inform the officer that the motorist is represented by legal counsel in the present matter. Basic information regarding the motorist's vehicle registration, motorist's insurance, driver's license number, vehicle's VIN number, etcetera can be supplied to law enforcement by the motorist's legal counsel. Accordingly, the present invention can reduce the opportunity for physical interactions between motorists and law enforcement.

In some implementations, an insignia of the software system consistent with the present invention may be stationed on an external area of the vehicle 301. For example, the indicia 303 may be a decal with a QR code which embeds information about the motorist. For example, the motorist's driver's license number, vehicle registrations, motorist insurance, etcetera may be retrieved by a law enforcement officer without a formal request from the motorist.

As will be discussed in detail herein, the motorist's legal counsel may communicate with law enforcement in various ways. For example, the motorist may have a central communications unit (as will be further described below) stationed within the vehicle 301 which can facilitate audible transmissions 302 from the motorist's legal counsel to law enforcement. In this example, the motorist may overhear a conversation between law enforcement and its legal counsel. However, the present invention is not limited to this implementation as further explained in detail below.

Lastly, in some implementations, if a motorist's legal counsel is unavailable by the time that law enforcement reaches the motorist's driver-side window for questioning, the central communications unit (not shown) may automatically issue a (default) statement from one of the system devices that the motorist is retained by legal counsel and that the motorist's legal counsel will be available shortly. The central communications unit may also be used to advise the motorist of its rights (e.g., Miranda rights) and may instruct the motorist to remain silent until its legal counsel is available to communicate directly with law enforcement.

Additionally, notifications may be sent to nearby persons (e.g., subscribers of a software system via a software application) to notify them of the motorist's present law enforcement investigation. The nearby subscribers may be prompted to document (e.g., witness notes) its account of the law enforcement investigation, take photos of the scene (e.g., still images), or make audio or video recordings of the present investigation. The nearby motorists may be further prompted to upload (via a software application) the aforementioned evidence associated with the present investigation to a set of servers which hosts the software application. In some embodiments, the aforementioned evidence may be also added to the motorist's incident transcript. Accordingly, the nearby subscribers can elect to serve as a witness to the investigation of the motorist. A software application which employs the present invention may facilitate an election of a subscriber to serve as a witness via an option within the software application.

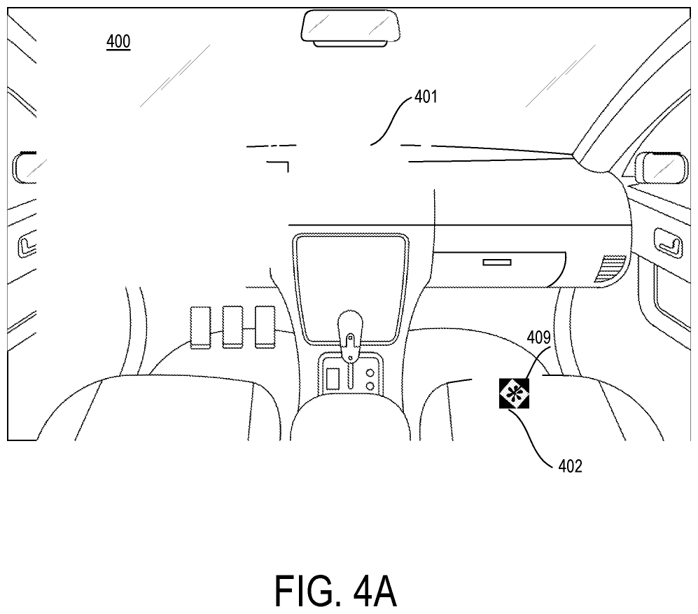

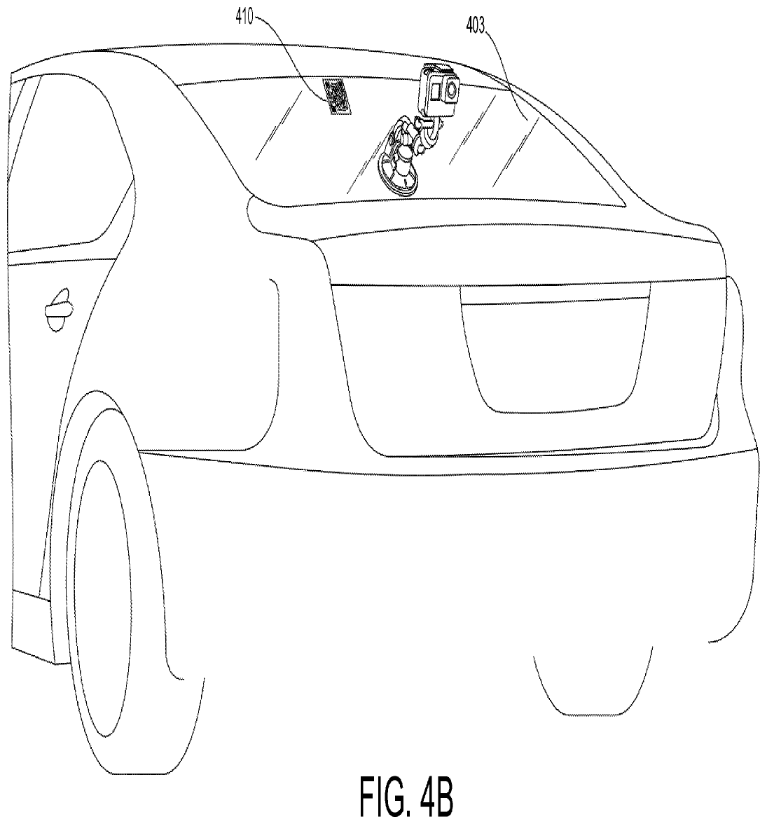

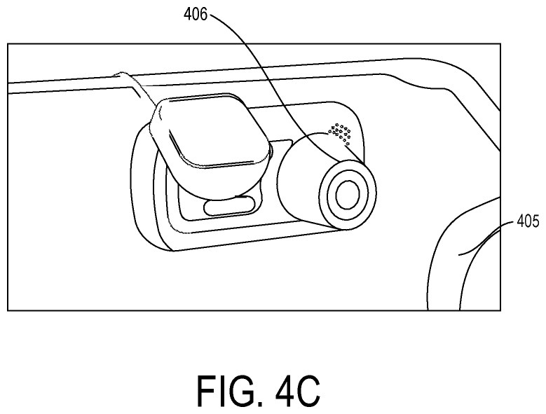

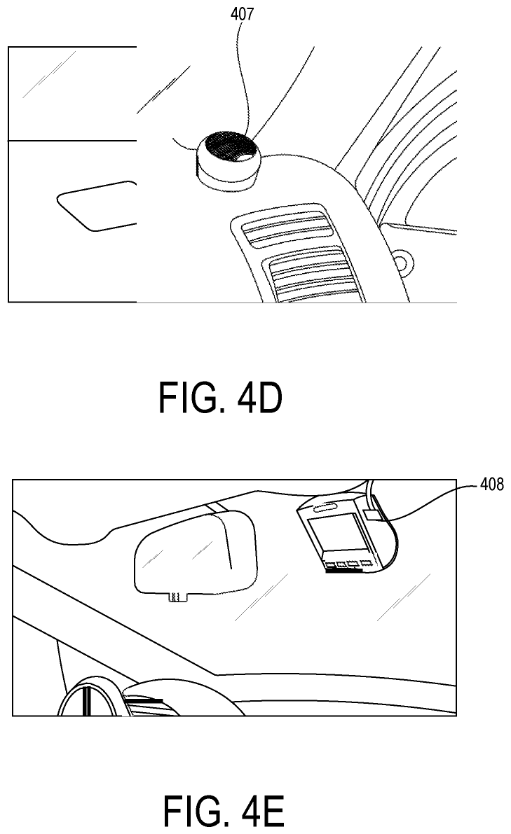

FIGS. 4A-4E are illustrations of a vehicle 400 with system devices which facilitate communication between a motorist, legal counsel, and law enforcement during a traffic stop, investigative stop, or detention. In the embodiment shown, the system devices include central communications unit 401, external video camera 403, dash camera 406, external speaker 407, and radar detector 408. In addition, the motorist's smartphone device 402 may operate as a system device in some implementations.

In some implementations, the central communications unit 401 are paired to one or more of the system devices. The central communications unit 401 may establish a network such that one or more network servers may be communicatively coupled to the system devices. As such, the system devices may be accessed and deployed by remote users and systems.

It should be understood by those having ordinary skill in the art that the present invention may include more than or less than the system devices shown in FIG. 4 so long as the present invention enables motorists to access legal counsel during law enforcement investigations and can facilitate communications between the motorist's legal counsel and law enforcement. Furthermore, although the system devices are shown to be discrete devices in the embodiment shown in FIG. 4, for other embodiments, one or more of the system devices may be embodied as distinct functions within the central communications unit 401.

FIG. 4A shows the front area of the vehicle 400. As shown, the central communications unit 401 is mounted on top of a dashboard within the vehicle 400. The central communications unit 401 may include router circuitry to receive and transmit packets of information to and from an external server or system device. In some embodiments, the central communications unit 401 is communicatively coupled to one or more servers and one or more system devices. In addition, to smartphone device 402, the system devices may also include at least one device which can facilitate voice calls.

Furthermore, the central communications unit 401 may receive an indication that a motorist is about to be detained or is being detained by law enforcement for an investigation. The central communications unit 401 may receive the indication by an audible, hands-free command or by way of manual input by the motorist or passenger. For example, if a motorist observes the presence of nearby law enforcement, the motorist can utter a voice command (e.g., “find local counsel”) in lieu of an impending traffic stop.

In other implementations, the central communications unit 401 may be enabled with radar detection functionality or may be paired to a radar detector 408 system device (see FIG. 4E). The radar detector 408 may detect whether a motorist's vehicle's speed is being monitored by law enforcement and therefore can detect the presence of nearby law enforcement.

In yet another implementation, mobile Internet allows the central communications unit 401, which may be equipped with GPS navigation capability, to map law enforcement locations in real-time. Moreover, the central communications unit 401 may have access to external software systems. For example, the central communications unit 401 may have access to software applications which render a live traffic map and to the present location of law enforcement which may be shared by other motorist subscribers of the software system.

Additionally, smartphone device 402 may host a software application 409 which facilitates a means for motorists to seek legal counsel and can readily inform the public of law enforcement investigations in real time. For example, a motorist may indicate, via the software application 409, that the motorist is being presently detained by law enforcement. In some implementations, the smartphone device 402 hosts one or more software applications which can send notifications to a motorist's contact list regarding the motorist's present detention.

In some implementations, the central communications unit 401 may include wireless capability to enable a connection to the Internet. In addition, the central communications unit 401 can facilitate a first channel of communication between law enforcement and the motorist's legal counsel. The central communications unit 401 can also facilitate a second channel of communication between the motorist and its legal counsel.

In one implementation, the first channel of communication may be facilitated by the central communications unit's 401 employment of an external speaker 407 to output communication from the motorist's legal counsel to law enforcement. However, in other implementations, the central communications unit 401 is equipped with speaker components. Notably, the external speaker 407 may be stationed internally or external to the vehicle 400.

In addition, the second channel of communication may be facilitated by the central communications unit's 401 establishment of a network such that packets of text messages and audible information can be transmitted to one or more system devices. In one implementation, when the second channel of communication is open, the first channel of communication is closed.

In some embodiments, the first channel of communication may provide confidential communication between the motorist and its legal counsel. Moreover, in other implementations, once the motorist's legal counsel has been selected, legal counsel may contact the motorist via a direct call or in-app voice call via smartphone device 402.

Because the central communications unit 401 may have GPS navigation capability and can be paired to external servers which can host subscribers to a software application 409 to facilitate a means for motorists to seek legal counsel during an investigation by law enforcement, the central communications unit 401 or motorist's smartphone device 402 may be used to send messages to nearby subscribers of the software application 409 to create witnesses of the traffic stop, investigative stop, or detention.

Furthermore, although the central communications unit 401 is shown in FIG. 4A as a discrete device, the present invention is not limited thereto. The central communications unit 401 may be integrated within a vehicle's controls system (not shown) by the vehicle's manufacturer and can perform the aforementioned capabilities previously described. Accordingly, in this embodiment, system devices that are not native to the vehicle 400 (e.g., peripheral devices) can be paired during a set up process. In addition, the video camera 403 may capture still images of a license plate or other identifying indicia on the law enforcement officer's vehicle. The captured still images may be uploaded and associated with the motorist's incident transcript.

FIG. 4B is an illustration of an exemplary video camera 403 which may be mounted to an inside or external area of the motorist's vehicle 400. Video camera 403 may be automatically engaged once the central communications unit 401 receives an indication that the motorist will be or is being detained by law enforcement. Accordingly, the central communications unit 401 can send commands to the video camera 403 to engage upon the unit's 401 receipt of the indication. In addition to video camera 403, the system devices may include several camera devices mounted to or affixed to the interior or exterior of the vehicle 400. Therefore, the video cameras 403 can capture still images and video footage of the present investigation.

FIG. 4C is an illustration of a dash camera 406 mounted within a dashboard 405 area of the vehicle 400. The dash camera 406 may be engaged once the central communications unit 401 receives an indication that a motorist is detained by law enforcement. The dash camera 406 may operate in conjunction with video camera 403 and any other system device cameras coupled to vehicle 400. For example, if video camera 403, dash camera 406, and any other system device cameras are capable of tracking, the central communications unit 401 can facilitate the movement of the video cameras in a coordinated manner to effectively capture footage of the investigation.

FIG. 4D is an illustration of an external speaker 407 which may be paired with a central communications unit 401. The external speaker 407 may be used for the motorist's legal counsel to communicate with law enforcement during a traffic stop, investigative stop, or detention.

In addition, the external speaker 407 may emit default messages. For example, the central communications unit 401 may emit via the external speaker 407 a message that the motorist counsel will be available shortly and may inform law enforcement that the motorist will be represented by legal counsel. In addition, the external speaker 407 may emit instructions for law enforcement officers to scan the software system insignia (see FIG. 3) to retrieve motorist and its vehicle information. Accordingly, the central communications unit 401 may emit audible messages pre-configured according to default system settings.

Moreover, the system devices may also include a discrete sound receiver device or functionality within central communications unit 401 which can detect and process sound. The sound receiver component within the central communications unit 401 may incorporate conventional devices (e.g., a diaphragm) to detect sound. Accordingly, a motorist can call for aid which can be detected by the central communications unit 401. In turn, the central communications unit 401 can dispatch a distress alert such that aid can arrive at the scene of the investigation to help the motorist in need.

For example, if the motorist is in a remote location, the motorist can utter a distress command such as “help” which the central communications unit 401 can be programmed to detect. The central communications unit 401 can send a distress notification to legal counsel, nearby subscribers, etcetera.

The central communications unit 401 may also engage system devices to engage audio or to visually generate distress alerts as well. In embodiments where the central communications unit 401 is integrated within a vehicle's 400 controls system, the central communications unit 401 can engage other vehicle devices native thereto (e.g., horn or front/rear lights) to generate distress alerts.

The present invention can create networks of central communication units, each stationed and assigned to different vehicles. Each of the central communication units may be coupled to one or more system servers and can therefore communicate with each other. Accordingly, in an event that a motorist is detained for a present law enforcement investigation, nearby motorists (e.g., motorist subscribers) which have access to its central communications system can engage its system devices in a manner to capture audio or video recordings of the law enforcement investigation if the nearby motorists drive close enough to the scene of the investigation.

In addition, if a distress signal is detected by the central communications unit (e.g., via system devices), the system software may send messages to nearby motorists to call in an emergency related to the law enforcement investigation. Moreover, in the instance that nearby motorists capture evidence related to the present law enforcement investigation, the evidence can be automatically uploaded to system servers and associated with the incident report associated with the motorist that is presently being detained.

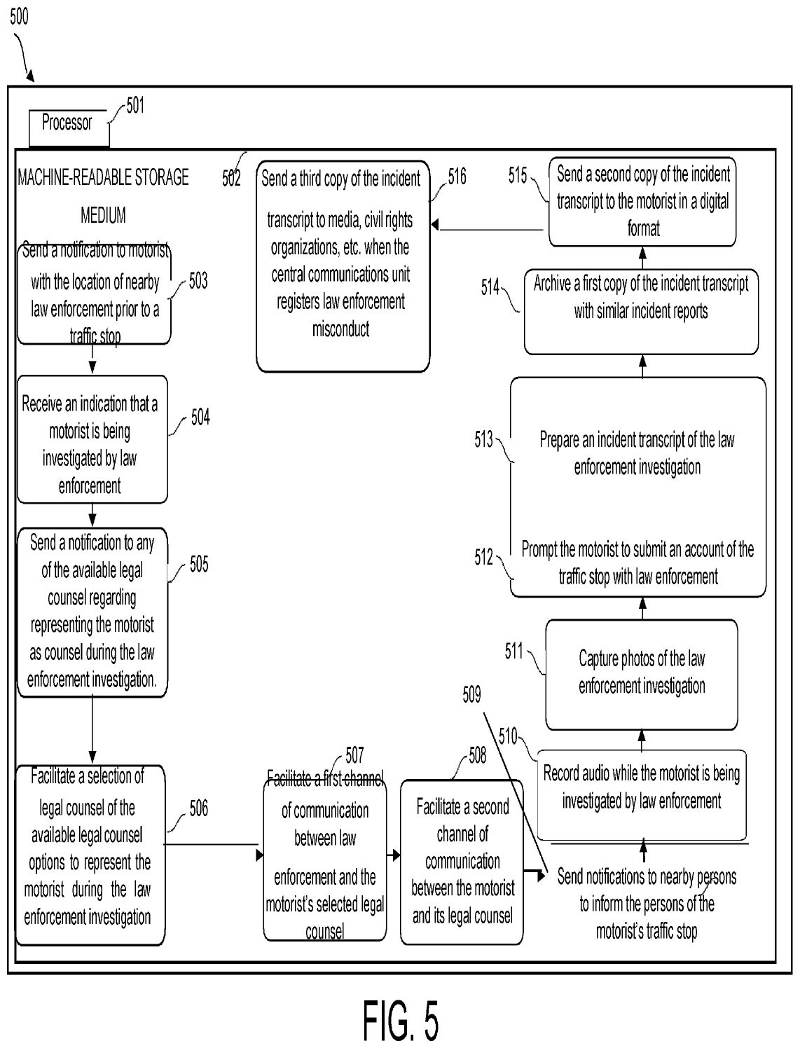

FIG. 5 is an illustration of a computing system 500 which can facilitate a communications system between remote parties during a law enforcement investigation according to one or more examples of the present invention. The computing system 500 may include a non-transitory computer readable medium 502 that includes computer executable instructions 503-516 stored thereon that, when executed by one or more processing units 501 (one processor shown), causes the one or more processing units 501 to effect a communication process consistent with the present invention.

Computer readable medium 502 includes computer executable instructions 503 which include instructions to send notifications to motorists with the location of nearby law enforcement prior to a traffic stop. Next, computer readable medium 502 includes computer executable instructions 504 which include instructions to receive an indication that a motorist is being investigated by law enforcement. Further, computer readable medium 502 may include computer executable instructions 505 which include instructions to send notification to any of the available legal counsel regarding representing the motorist as counsel during the law enforcement investigation. The notifications may be sent to legal counsel based on counsel profiles (e.g., the location, area of practice, review ratings, etc.). In addition, computer readable medium 502 includes computer executable instructions 506 which include instructions to facilitate a selection of legal counsel of the available legal counsel options to represent the motorist during the law enforcement investigation.

Computer readable medium 502 also includes computer executable instructions 507 which include instructions to facilitate a first channel of communication between law enforcement and the motorist's selected legal counsel. In addition, computer readable medium 502 includes computer executable instructions 508 which include instructions to facilitate a second channel of communication between the motorist and its legal counsel.

Computer readable medium 502 further includes computer executable instructions 509 which include instructions to send notifications to nearby persons to inform the persons of the motorist's traffic stop. Further, computer readable medium 502 includes computer executable instructions 510 which include instructions to record audio while the motorist is being investigated by law enforcement. Further, computer readable medium 502 includes computer executable instructions 511 which include instructions to capture photos of the law enforcement investigation.

Computer readable medium 502 includes computer executable instructions 512 which include instructions to prompt the motorist to submit an account of the traffic stop with law enforcement. Computer readable medium 502 includes computer executable instructions 513 which include instructions to prepare an incident transcript of the law enforcement investigation that includes an identification (e.g., a driver's license) of the motorist, the motorist's legal counsel, law enforcement, any recorded audio or captured photographs, a timestamp of the investigative stop; and the motorist's account of the law enforcement investigation.

Furthermore, computer readable medium 502 includes computer executable instructions 514 which include instructions to archive a first copy of the incident transcript with similar incident reports. Computer readable medium 502 further includes computer executable instructions 515 to send a second copy of the incident transcript to the motorist in a digital format. Further, computer readable medium 502 may include computer executable instructions 516 which include instructions to send a third copy of the incident transcript to media, civil rights organizations, etcetera (e.g., via a social media post) when the central communications unit registers law enforcement misconduct.

The present invention may facilitate the use of machine learning and artificial intelligence technologies to detect trends within the uploaded incident transcripts. For example, the archive of incident transcripts may be processed to discover law enforcement tendencies, regional norms, etcetera. Moreover, the processed data may reveal trends of the interaction between motorists and law enforcement according to race, gender, etc. (African American motorist and White American police officers, etc.). The trend data can be used to improve criminal procedure protocols and the relationship between law enforcement and the public.

With the motorists' consent, each incident transcript can be subjected to machine learning with the intent to identify law enforcement investigations which do not conform to the norm. These cases can be further reviewed by legal counsel. If legal counsel determines that the motorists' encounter with law enforcement requires further action, the legal counsel can send a message when the software application recommends that a complaint be filed.

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be included within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

What is claimed is:

1. A non-transitory machine-readable storage medium containing instructions that, when executed:
receive from a set of servers at a first device operated by legal counsel a first set of notifications from a plurality of motorists within a pre-determined location that seek legal representation during a traffic stop;
send from the first device to a second device a first indication which includes an assent to legal representation for a first selected motorist of the plurality of motorists;
create a first channel of communication between law enforcement present at the traffic stop and the legal counsel;
wherein the first channel of communication is created between the law enforcement and the legal counsel via a central communications unit,
wherein the central communications unit is communicatively coupled to the set of servers, and
create a second channel of communication between the legal counsel and the first selected motorist via the first device,
wherein the central communications unit is configured such that when the second channel of communication is open, the first channel of communication is closed such that the first selected motorist can communicate privately with the legal counsel.

2. The non-transitory machine-readable storage medium of claim 1, wherein the first device received a notification associated with the first selected motorist due to the proximity of the first device and the second device operated by the first selected motorist.

3. The non-transitory machine-readable storage medium of claim 1, wherein the legal counsel which received the first set of notifications due to the legal counsel's area of practice and review ratings.

4. The non-transitory machine-readable storage medium of claim 1, wherein the first device can retrieve user profiles of each of the plurality of motorists from the set of servers.

5. The non-transitory machine-readable storage medium of claim 1, wherein the first indication is sent from the first device to the second device via the set of servers.

6. The non-transitory machine-readable storage medium of claim 1,
further comprising sending from the first device to the second device via the set of servers a second indication which includes an assent to legal representation for a second selected motorist of the plurality of motorists.

7. The non-transitory machine-readable storage medium of claim 1, wherein the first device and the second device are smartphones.

8. The non-transitory machine-readable storage medium of claim 1, wherein the legal counsel can elect via the first device to receive the first set of notifications and additional notifications to the first device.

9. The non-transitory machine-readable storage medium of claim 1, wherein the legal counsel can elect to receive notifications for specific legal matters.

10. The non-transitory machine-readable storage medium of claim 1, wherein the legal counsel can elect to receive notifications for traffic stops that occur in specific regions.

11. A non-transitory machine-readable storage medium containing instructions that, when executed:
receive from a set of servers at a first device operated by an observer non-attorney a first set of notifications from a plurality of motorists within a pre-determined area that seek a witness to a traffic stop;
send from the first device to a second device a first indication which includes an assent to being a first observer for a first selected motorist of the plurality of motorists;
create a first channel of communication between law enforcement present at the traffic stop and the first observer;
wherein the first channel of communication is created between the law enforcement and the first observer via a central communications unit,
wherein the central communications unit is communicatively coupled to the set of servers, and
create a second channel of communication between the first observer and the first selected motorist via the first device,
wherein the central communications unit is configured such that when the second channel of communication is open, the first channel of communication is closed such that the first selected motorist can communicate privately with the first observer.

12. The non-transitory machine-readable storage medium of claim 11, wherein the central communications unit is coupled to a set of system devices.

13. The non-transitory machine-readable storage medium of claim 11, wherein the set of system devices are operable to prepare an incident transcript of the law enforcement investigation which includes at least one of a motorist identification, the selected legal counsel of the available legal counsel, a law enforcement identification, recorded audio, captured photographs, and an investigation time stamp.

14. The non-transitory machine-readable storage medium of claim 11, further comprising sending a second set of notifications to the selected motorist's contact list regarding the traffic stop.

15. The non-transitory machine-readable storage medium of claim 11, wherein the first observer is a contact in the selected motorist's contact list.
